(19) United States
(12) Patent Application Publication
(10) Pub. No.: US 2019/0161204 A1
(43) Pub. Date: May 30, 2019

(54) AIRCRAFT, LIGHTNING-PROTECTION SYSTEM, AND METHOD OF PROVIDING THE LIGHTNING PROTECTION

(71) Applicant: Thomas RIEDEL, Wuppertal (DE)

(72) Inventor: Thomas RIEDEL, Wuppertal (DE)

(21) Appl. No.: 16/173,621

(22) Filed: Oct. 29, 2018

(30) Foreign Application Priority Data
Nov. 28, 2017 (DE) 102017128075.8
Jan. 24, 2018 (DE) 102018101556.9

(51) Int. Cl. B64D 45/02; B64C 39/02

(52) U.S. Cl. CPC B64D 45/02; B64C 39/024; B64C 2201/042; H04B 10/2575; B64C 2201/122; B64C 2201/12; B64C 2201/06

(57) ABSTRACT

The invention relates inter alia to a drone (10) comprising at least one electromotive drive (24a, 24b) and a controller (33, 33a, 33b), wherein the drone can permanently maintain a set flight position with the aid of the controller, wherein the drone that is in the flight position thereof is connected to a ground station (11) by a cable (13), wherein the cable comprises at least two electrical conductors (27a, 27b, 27c, 27d, 27e, 27f, 27g) for supplying voltage to the drive, wherein the drone comprises lightning-protection means (34a, 34b, 34c) that protects the controller and/or the drive and/or other electronic component parts of the drone from lightning strikes, wherein the overall cross section of the electrical conductors of the cable allows for high electrical currents, caused by lightning strikes, to be conducted away from the drone (10) to the ground station (11), and wherein the cable is connected to a lightning transfer point (16) in the earth (15), in the region of the ground station.

The invention relates to an aircraft according to claim 1.

Aircraft of the type in question are known and are increasingly widespread. The aircraft of the type in question are conventionally also referred to as drones. They comprise a supporting structure or a supporting body on which a battery, or in general an accumulator, is arranged, which battery is used to drive at least one electric motor. In general, a plurality of drives is provided, specifically one drive for each of the motors. Drones or aerial drones of this kind are also referred to as multicopters. According to the number of motors—and the number of electromotive drives—for example quadcopters are known which therefore comprise four motors.

Depending on the design, aerial drones of this kind may also have a significantly higher number of motors. For example, drones having twelve or more drives are known.

The known drone obtains its voltage supply from a generally rechargeable, optionally also replaceable, accumulator. The flight time of the drone is limited by the nominal capacity of the accumulator. The drone has a specified maximum bearing load, and therefore the structural size of the accumulator is also subject to restrictions.

Proceeding from a drone that is known from public prior use and for which there is no documentary evidence, the object of the invention is that of developing the drone such that it can a be used in new fields of application.

This object is achieved by the invention using the features of claim 1.

The invention relates to a drone comprising at least one electromotive drive. The drone according to the invention preferably comprises a plurality of electromotive drives, for example two or three electric motors. More preferably, the number of electromotive drives, i.e. the number of electric motors, corresponds to the number of rotors or propellers provided, such that each rotor normally has one electric motor.

The drone further comprises a controller that can permanently maintain the drone in a set flight position. The controller is an electronics unit that is preferably arranged directly on the drone, in particular comprising at least one processor that can ensure a stable or largely stable relative location of the drone, using suitable sensors, such as position change sensors and/or acceleration sensors and/or position sensors. In particular, the controller is capable of permanently maintaining the desired flight position without the need for continual or regular intervention by an operator.

For this purpose, conventional controller and control methods can be used that are already used in conventional drones, in particular in conventional drones, and are per se known.

The drone can thus be steered towards a specific location, e.g. can assume a specific position at a specific spacing from a specified body that is attached to the ground, and can then automatically permanently maintain the selected flight position.

According to the invention, the drone can be connected to a ground station by a cable. For this purpose, the drone preferably comprises at least one terminal for releasably connecting the drone to the cable. The cable can furthermore be connected to a ground station. The ground station is firmly arranged on the ground.

The cable may be of a length of for example between 5 and 500 meters, preferably a length of between 20 and 120 meters. The drone can be brought into a flight position that has a maximum altitude, i.e. a spacing from the ground, that corresponds to the length of the cable.

Furthermore, according to the invention, the cable comprises at least two electrical conductors for supplying voltage to the drive.

In this respect, the drone obtains the operating voltage that powers the electromotive drives directly from the ground station, via the cable. In this respect, the drone no longer needs to itself comprise its own transportable batteries or an accumulator at all. The voltage supply to the drive can be achieved exclusively, or at least in part or temporarily, via the cable. In particular, the drone can remain in the set flight position for virtually any length of time, i.e. for example even for several hours or days, by a permanent voltage supply being ensured.

It should be noted that, according to an advantageous embodiment of the invention, owing to the possibility, provided according to the invention, of maintaining the flight position for significantly longer, the drone also provides the possibility of correcting the actual current flight position relative to the set target flight position, and can carry out a correction of this kind.

While the controller of a drone of the conventional type already comprises astonishingly exact and precise mechanisms for maintaining a set flight position even in the case of wind, and even in the case of strong winds, correction of the flight position actually achieved, with respect to the set target flight position, may become necessary in the case of the continuous operation times of several hours or even several days (up to weeks) that are possible according to the invention. For this purpose, the drone may comprise specific position correction means that ensure automatic return of the drone into the target flight position, for example in the event of the occurrence of deviations, outside of specified target boundaries, from the target flight position. For example GPS positioning or repositioning aids, or other suitable position measurement and position correction methods, may be provided for this purpose.

According to the invention, the drone furthermore comprises lightning-protection means. The lightning-protection means is attached to the drone and/or assigned to the drone. The lightning-protection means is initially used for protecting the drone from permanent damage in the form of a lightning strike. In particular, the lightning-protection means is intended to be used for protecting the controller of the drone and/or the drive or the drives of the drone from lightning strikes. For this purpose, the lightning-protection means may for example comprise one or more devices in the form of a surge arrester. A surge arrester can be used for example for protecting electronic or electrical parts or components of the drone from voltages and/or currents that are too high. For this purpose, it may also be possible, for example, for the lightning-protection means to comprise one or more fuses.

The fuses may be controllable or switchable. The lightning-protection means may also be provided by one or more electronic component parts of the drone being redundant, such that for example in the event of outage of an electronic component part, for example a controller of the drone, another component part, i.e. for example a second, redundant control device or a corresponding controller, can take on the function of the failed electronic component part promptly following the outage of said electronic component part.

Within the meaning of the present patent application, in an embodiment of the invention lightning-protection means of the drone is also understood to be a device that ensures that, in the event of a lightning strike in the drone, the drone can maintain its set position or can quickly assume said position again after a very brief outage, in particular can assume said position without the need for intervention by an operator.

Conventional components that are known per se for achieving lightning-protection for electronic component parts can be used for this purpose.

According to the invention, the cable is furthermore designed such that it can safely conduct the lightning strike into the earth. For this purpose, said cable comprises at least to electrical conductors, the overall cross section of which is sufficiently large for the cable to allow high electrical currents, as are caused in the event of lightning strikes, to be conducted from the drone to the ground station.

According to the applicant's current calculations, the minimum overall cross section that a plurality of electrical conductors must amount to in total in order for it to be possible to ensure that the lightning is conducted away is approximately at least 10 mm². It is also conceivable, however, to reduce said minimum cross section, in some circumstances, to even smaller overall cross sections of at least 5 mm², depending on the positioning and arrangement and selection of the number of electrical conductors of the cable.

It should be noted that, according to current lightning-protection standards, even larger cross sections, specifically of at least 50 mm², should be used. However, owing to the calculations, developments and research conducted by the applicant, smaller required overall cross sections of at least 10 mm² are to be considered sufficient in the use according to the invention.

According to the invention, the cable comprises at least two electrical conductors that supply operating voltage from the ground station to the drives of the drone. It is sufficient, within the meaning of the invention, for at least one of the two conductors to have a large conductor cross section that allows for the lightning to be conducted away. The invention also covers the case of both conductors together having a sufficiently large overall cross section.

However, the invention finally also covers the case of a third conductor also being provided in addition, or of a plurality of further conductors being provided, the overall cross section of all the conductors reaching the minimum dimension of at least 5 mm² or in particular more than 10 mm².

The cable in any case has an overall cross section that can conduct away electrical currents, as are generated in the case of lightning strikes, from the drone to the ground station, and further into the earth.

According to the invention, the cable furthermore can be or is connected, in the region of the ground station, to a lightning transfer point in the earth. The lightning transfer point may also be formed by a lightning transfer region.

According to current lightning-protection standards, in order to achieve or comply with specific lightning-protection classes it is necessary for the high currents and voltages caused by the lightning to be transferred directly to the earth. For example earth probes are bored into the earth as a result. The lightning transfer points are advantageously provided at a depth of at least 3 meters. In some circumstances, slightly lower depths, possibly only 2 meters deep, in specific cases also only 2 meter deep, may also be used. The decisive factor is that the relevant electrical conductors of the cable that contribute to conducting the lightning away are connected, indirectly or directly, to the earth, such that the lightning can be passed directly into the earth.

According to the invention, the drone allows for protection a specific region or site on the earth to be protected from lightning strikes. It is thus possible, for example, to ensure that visitors, artists and event technicians are protected from lightning strikes, for example during an event such as a sports competition or a music event, for example an open-air music concert.

For this purpose, the drone is connected to the ground station by the cable, and a flight position of the drone is set at an altitude that is higher than all ground unevenness or structures or buildings or elevations of the site. It is known that lightning strikes the highest point in the site, and therefore in the present case the lightning would hit the drone. The lightning is then conducted from the drone, i.e. the drone, directly into the earth, and in particular to a sufficient depth that the people present at the music concert are not exposed to the lightning strikes and the course of the event is not affected.

The invention further covers the case of a plurality of drones, preferably each connected to an individual ground station, flying or hovering over the event in the form of a raster or array, at a specified maximum mutual spacing of for example 40 or 80 meters apart, in the manner of grid points. The running of the event is not affected by the existence and presence of the drones either, because the drones do not create any noise pollution or any dangers or risks.

On the contrary, according to the invention the drones can also be used to allow for wireless communication and to provide for example a radio network for transmitting data or audio or video information having improved properties, for example improved transmission and reception quality.

According to an advantageous embodiment of the invention, the depth of the lightning transfer point in the earth is at least 1 meter, in particular at least 2 meters, more particularly at least 3 meters. This makes it possible to allow for existing lightning-protection requirements according to legal provisions and to ensure that the lightning is safely conducted into the earth.

According to a further advantageous embodiment, the lightning-protection means comprises a surge arrester and/or a redundant configuration of electronic component parts of the drone, in particular a redundant configuration of the controller. According to this embodiment of the invention it is possible to reliably prevent the function of the electronic component parts of the drone, in particular also the controller of the drone, from being impaired, in particular also by drawing on conventional surge arrester means. A redundant configuration and arrangement of electronic component parts, in particular redundant configuration of the controller, also makes it possible to ensure a high level of operational reliability of the drone and the failure-safety thereof.

According to a further advantageous embodiment of the invention, the electrical conductors of the cable also comprise copper conductors. It is thus possible to use conventional calculations for minimum overall cross sections which are required in the case of a lightning strike.

According to a further advantageous embodiment of the invention, the overall cross section of all of the electrical conductors of the cable is at least 5 mm², in particular at least 8 mm², more particularly at least 10 mm², and more particularly at least 12 mm². Sufficiently large overall cross sections are thus provided, which cross sections allow for high currents, caused by lightning strikes, to be conducted away, and reliably ensure that the lightning passes from the drone to the ground station and into the earth exclusively via the cable.

According to a further advantageous embodiment of the invention, the flight position of the drone is can be set. As a result, the flight position of the drone can be set in a wireless or wired manner, for example manually, using remote controller, either via the ground station or alternatively directly via a radio device.

According to a further advantageous embodiment of the invention, the cable comprises a plurality of conductors that all contribute to conducting away the lightning strike. However, the invention also comprises an embodiment in which just one electrical conductor having a particularly large cross section is provided on the cable in order to allow for the lightning to be conducted away.

However, according to a further advantageous embodiment of the invention, the invention also covers the case of the cable comprising a plurality of conductors that contribute together to conducting away the lightning strike. Distributing the high currents, caused in the event of a lightning strike, over a plurality of conductors allows the necessary overall cross sections to be kept small, because physical effects arise of which use can be made.

According to a further advantageous embodiment of the invention, the drone comprises a communications unit that can establish wireless communication with other subscribers of a radio network. Since the drone assumes the flight position thereof at a particularly high altitude, far above the site to be protected from lightning strikes, this high altitude can also advantageously be used for establishing direct radio links to other subscribers.

According to a further advantageous embodiment of the invention, the cable comprises a fiber optic cable that can transmit data from the ground station to the communications unit or that can transmit data from the communications unit to the ground station.

In this case, the cable is designed in the manner of a hybrid cable. The cable comprises at least one optical fiber that allows for data or signals to be transmitted optically. For this purpose, data and/or signals can be transmitted, unidirectionally or bidirectionally, between the drone and the ground station. In this case the fiber optic cable allows for very high data transfer rates, and in particular also a particularly simple possibility for coupling the data and/or signals into and back out of the optical fibers, both on the drone and at the ground station.

In particular, a data transfer method is possible which operates as a radio over fiber (RoF) or RF over fiber (RFoF) method. Using this technology, a luminous flux conducted via the optical fiber is modulated using a radio frequency signal.

At the same time, however, the cable comprises at least two electrical conductors for supplying voltage to the drive. The electrical drives on the drone can be supplied either with direct voltage or with alternating voltage, by mean of the at least two electrical conductors.

The cable of this embodiment can make use of conventional electrical conductors and conventional fiber optic cables, and can combine said conductors and cables with one another to form cable according to the invention. For example, two electrical conductors (or a plurality of electrical conductors) can be connected, e.g. adhesively bonded, welded or connected at points or in regions or specific locations, to a conventional optical fiber. However, the invention also covers cable of a hybrid type, in which for example one fiber optic cable is encased in two electrically conductive sheaths that are separated from one another by an intermediate layer that is located therebetween.

The hybrid cable according to the invention can be produced having a weight in an order of magnitude of approximately 4-20 kilograms, at a length of 100 meters. A conventional aerial drone can stand bearing loads up to for example 15-25 kilograms. After subtracting the approximately 4 kilograms for the hybrid cable, there is still for example a residual bearing load of for example 11 kilograms.

This makes it possible to arrange transmitting and receiving technology on the drone, including arranging electro-optical transducers or optical electrical transducers which can couple signals into or out of the optical fibers.

The technology to be installed by the drone can be limited to antennae, filters, e.g. duplexers, transmission and reception amplifiers, and transducers.

The signal processing technology, including the transmission and reception technology and the amplifiers, which is far more complex in design and heavier than the transmission and/or reception technology on the drone, can be arranged on the ground station. Arranging said signal processing technology on the aerial drone is in any case not possible, taking account of the low bearing loads.

The drone according to the invention can thus be used as a central element of a radio network. In particular, the drone can be used for radio networks that are to be established temporarily, for example for reporting at large-scale sports meetings, or events. These events are often associated with poor radio quality, for example owing to shadowing. For this purpose, it was conventional in the prior art to construct radio masts or to provide aerial platforms that have the heavy transmission and reception technology arranged in the lifting carriage and, owing to the raised position, i.e. high above the ground, allowed for a good radio link to the individual subscribers. According to the invention, the use of lifting carriages of this kind can be omitted when using the drone according to the invention.

According to the invention, at least one antenna is arranged on the drone. The antenna may operate as a receiving antenna, or as a transmitting antenna, or as a transmit and receive antenna.

The drone according to the invention can be used in a radio network in order to establish a radio link to a plurality of subscribers. In a first operating mode, the drone is designed to receive radio signals transmitted by subscribers, to couple said signals into the optical fiber by an electro-optical transducer, and to conduct said signals to the ground station. In the ground station the signals are then decoupled from the optical fiber, using an optoelectronic transducer, optionally having an amplifier interposed, and further processed.

According to a further alternative operating mode, the drone is designed to transmit radio signals to subscribers of the radio network, using an antenna arranged on the drone. For this purpose, signals are coupled into the optical fiber from the ground station, using an electro-optical transducer, and the signals are coupled out using an optoelectronic transducer unit on the drone, and are then emitted by the antenna, optionally after amplification.

The two operating modes described above can each be achieved in unidirectional operation of the cable.

However, the invention also covers the case of both receive and transmit mode occurring, within the context of bidirectional operation. In this case, the drone can be used in the manner of an optical repeater, and can transmit the signals received by the subscribers of the radio network to the ground station for the purpose of amplification, and, after receiving amplified signals from the ground station, can emit said signals again as radio signals. This significantly improves the radio network quality and the range of the radio network.

The invention also covers the case of the cable comprising one or more optical fibers.

It is generally possible to use a fiber optic cable for bidirectional operation.

The two electrical conductors which provide a voltage supply for the electromotive drive can at the same time also provide a voltage supply of the electronic components of the signal transmission and reception technology on the drone. However, the invention also covers the case of further, separate electrical conductors also being carried on the drone, as components of the cable, in order to achieve the voltage supply for the transmission and reception technology.

In general, however, the aim of the invention is to design the cable so as to be as lightweight as possible in construction.

According to an advantageous embodiment of the invention, a transmitting and/or receiving unit for radio signals is arranged on the drone. The transmitting and/or receiving unit for radio signals may comprise one or more antennae. Said unit can furthermore comprise one or more electronic component parts that carry out the necessary signal processing in order to feed received radio signals to the electrooptical transducer, with the aim of optically coupling said signals onto the fiber optic cable, and/or comprise the necessary electronic components in order to convert optical signals, coupled out of the optical fiber, into electrical signals and to process said signals such that they can be transmitted via an antenna.

In principle, conventional electronic component parts can be used for providing a transmitting and/or receiving unit on the drone.

Furthermore, according to the invention, a transducer unit is arranged on the drone, which unit converts electronic signals into optical signals that can be coupled onto the fiber optic cable. It is furthermore and/or alternatively possible for a transducer unit to be provided on the drone that converts optical signals that can be coupled out of the fiber optic cable into electrical signals. Here, too, the invention can use conventional electronic parts and component parts for the transducer unit.

According to a further advantageous embodiment of the invention, the drone comprises a terminal via which the fiber optic cable can be releasably attached. Conventional interfaces can be used here for example. These may be plug connections for example.

According to a further advantageous embodiment of the invention, the drone can be connected to the ground station by the cable. This can make it possible for the drone to maintain a set flight position over very long periods of time, while a voltage supply is continuously provided.

According to a further advantageous embodiment of the invention, the drone is designed in the manner of a drone. More advantageously, the drone is designed in the manner of a multicopter, e.g. in the manner of a quadcopter, or alternatively as a helicopter. This makes it possible to draw on conventional drones which can be modified in accordance with the invention, for example can be provided with a transceiver unit, with a transducer unit, and/or with a terminal for cable.

The invention further relates to a lightning-protection system according to claim 10.

The object of the invention is that of providing a lightning-protection system for achieving lightning-protection for a site.

This object is achieved by the invention by the features of claim 10.

In order to avoid repetitions, regarding the understanding of the teaching of claim 10 and regarding the terms and features used and the configuration thereof reference can be made to the above explanations.

According to a further aspect, the invention relates to a method of providing lightning-protection for a site, according to claim 20.

The object of the invention is that of specifying a method of this kind.

The invention is achieved by the features of claim 20.

Again, in order to avoid repetitions, reference is made to the above explanations which also explain the teaching of the invention according to claim 20.

Further advantages can be found in the dependent claims, which have not been cited, and with reference to the following description of the embodiments shown in the drawings. In the drawings:

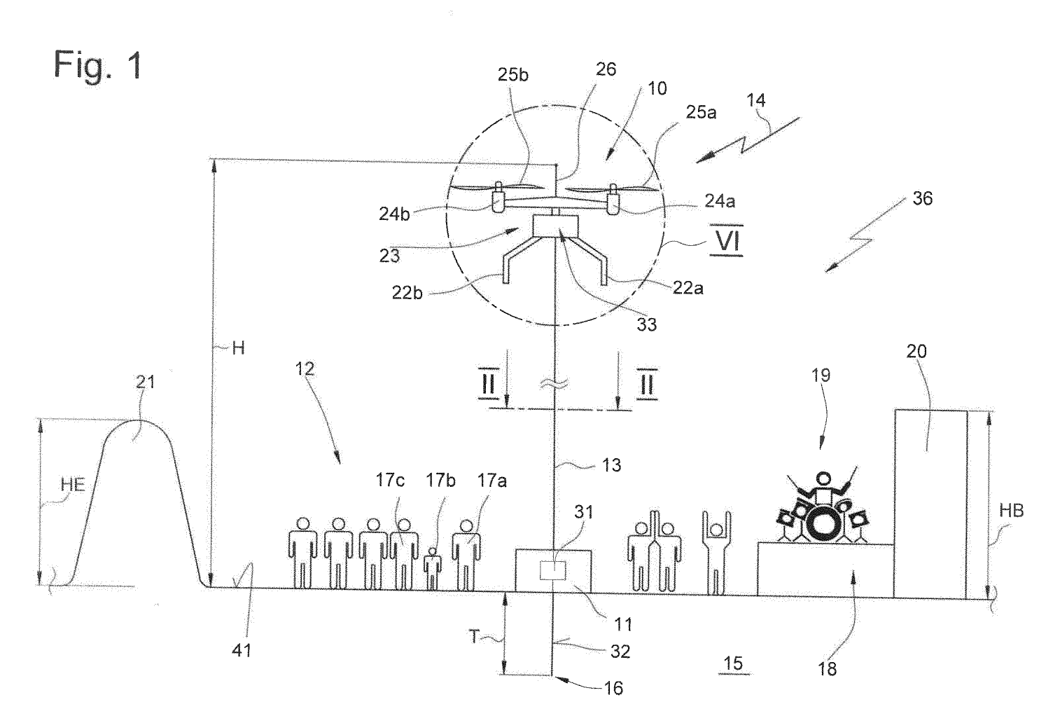

FIG. 1 is a partially sectional schematic view of a first embodiment of a drone according to the invention and of a lightning-protection system according to the invention comprising a ground station that is shown schematically and is connected to a drone by a cable (shown by broken lines), which drone assumes a set flight position above an event site,

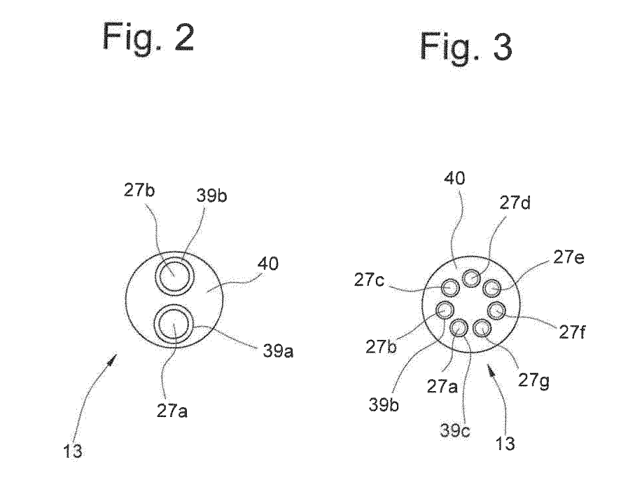

FIG. 2 is a schematic cross section, approximately according to the line II-II in FIG. 1, of a first embodiment of a cable for providing a connection between the drone and the ground station, the cable comprising two conductors,

FIG. 3 shows a section through a further embodiment of a cable, in a view according to FIG. 2, comprising seven conductors,

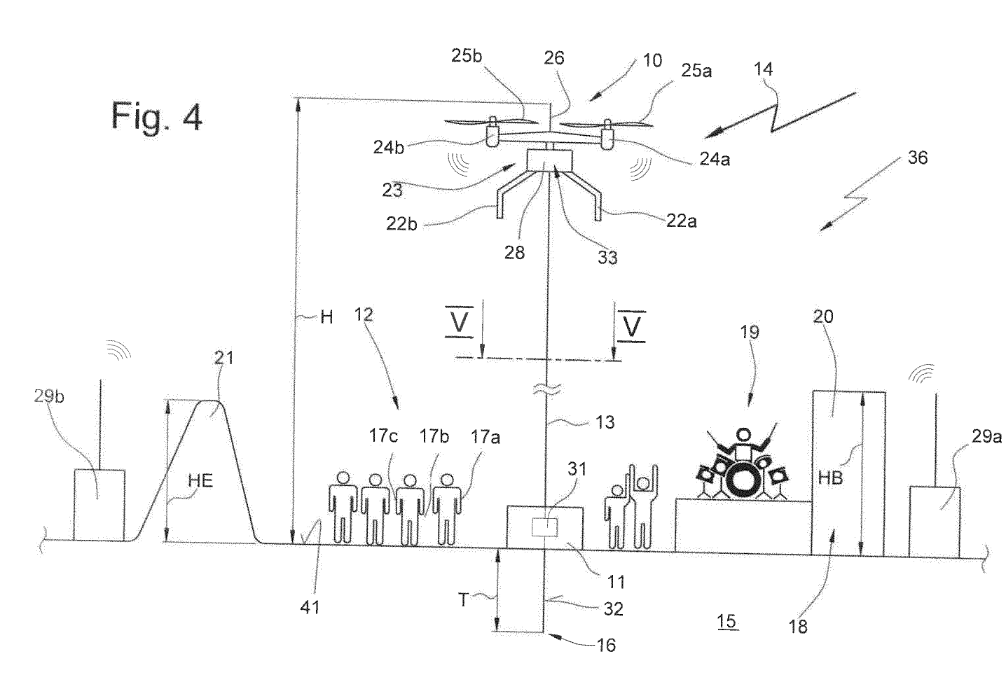

FIG. 4 shows a further embodiment of a drone according to the invention and a lightning-protection system according to the invention, in a view according to FIG. 1, the drone additionally comprising a communications unit for providing a radio network,

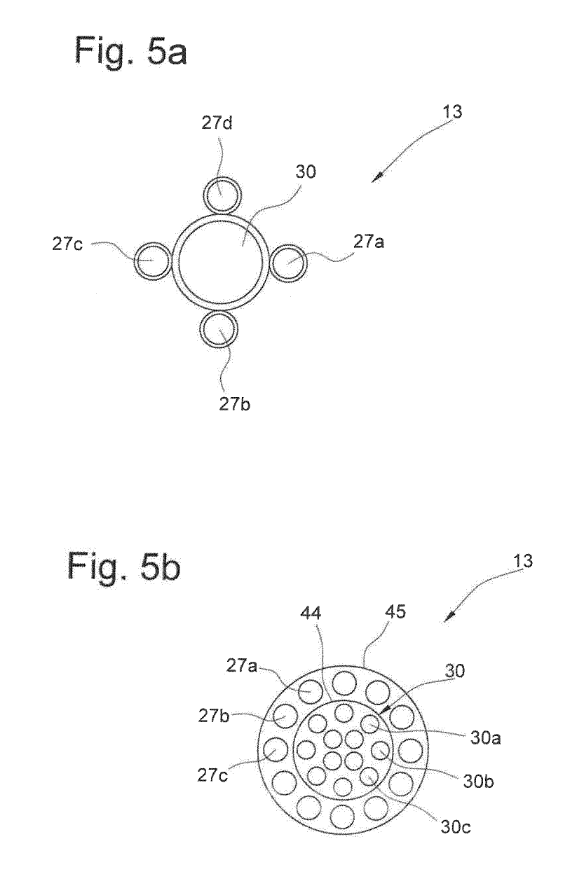

FIG. 5a shows an embodiment of a cross section of cable, also comprising a fiber optic cable, approximately according to the cutting line V-V in FIG. 4,

FIG. 5b shows a further embodiment of a cross section of the cable, in a view according to FIG. 5a,

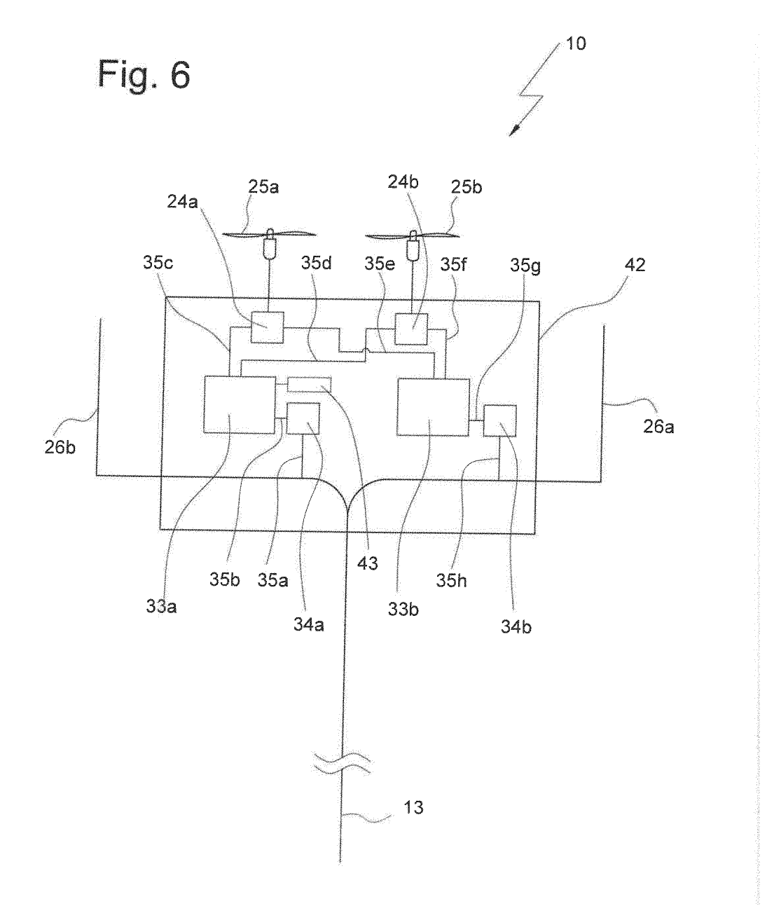

FIG. 6 is an enlarged partially sectional schematic view, in the manner of a block diagram, of an embodiment of a drone, approximately according to the pitch circle VI in FIG. 1, some electronic components of the drone being shown,

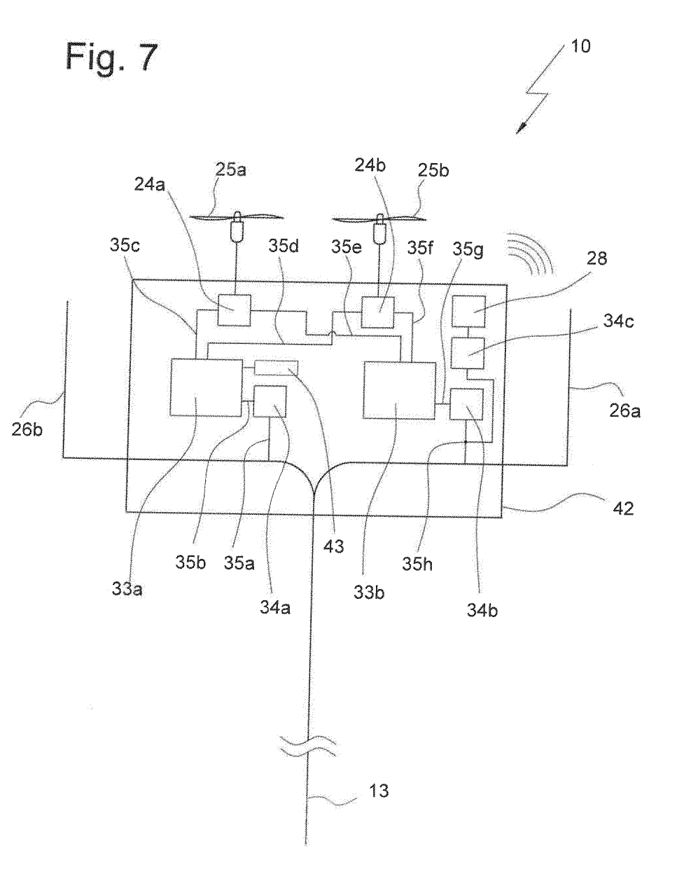

FIG. 7 shows a further embodiment of a drone in a view according to FIG. 6, a communications unit additionally being provided,

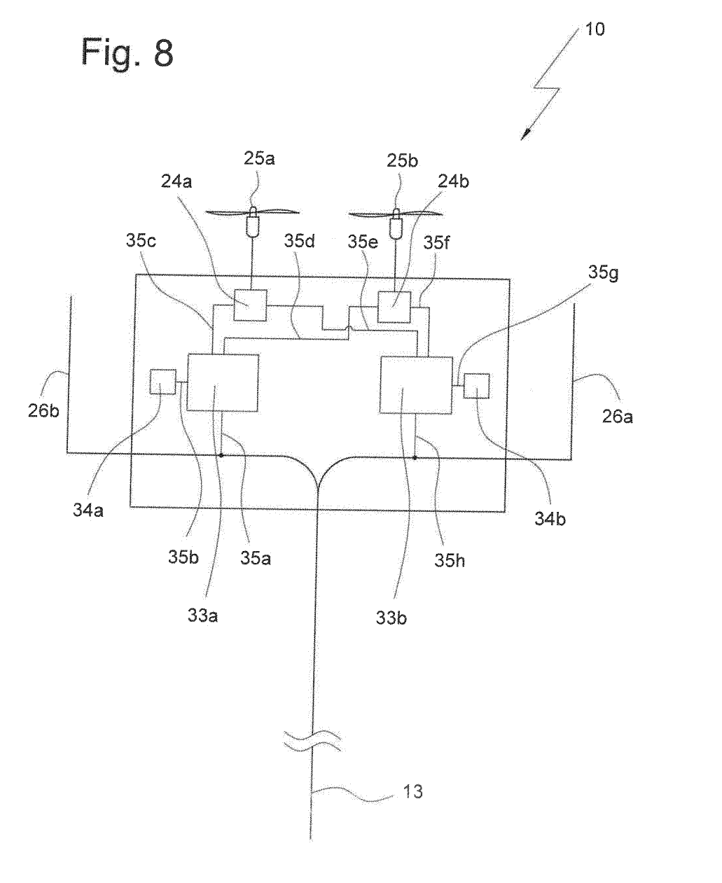

FIG. 8 shows a further embodiment of a drone according to the invention in a view according to FIG. 6, modified lightning-protection means being provided,

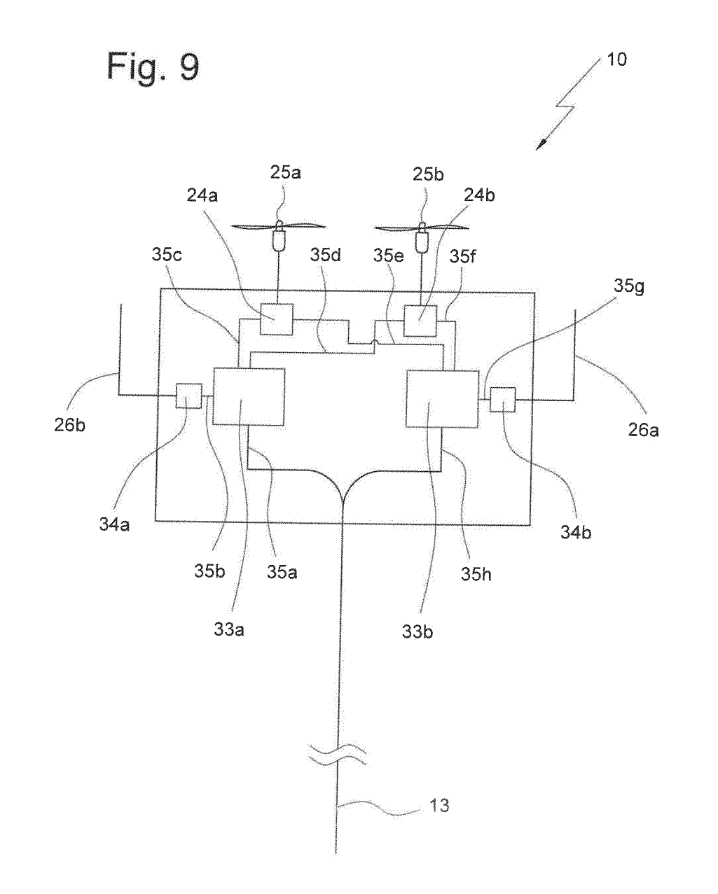

FIG. 9 shows a further embodiment of a drone in a view according to FIG. 6, modified lightning-protection means again being provided, and

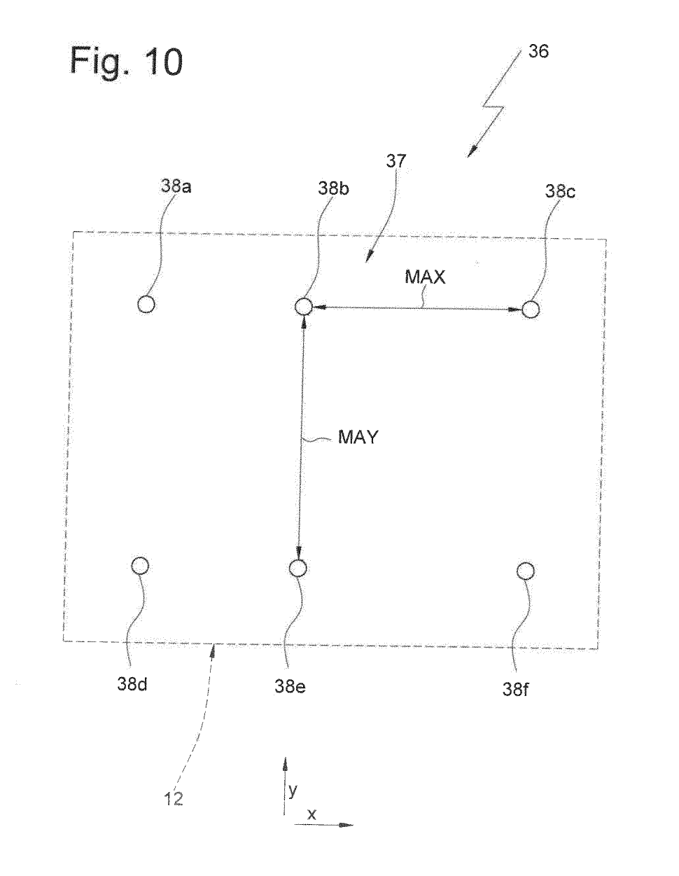

FIG. 10 is a schematic plan view of an event site over which a plurality of drones, in the embodiment of FIG. 10 a total of six drones, are arranged for lightning-protection purposes, which devices are mutually spaced by a specified maximum spacing and are arranged in the manner of grid points.

Embodiments of the invention are described by way of example in the following description of the figures, with reference to the drawings. In this case, for the sake of clarity, even if different embodiments are involved, the same or comparable parts or elements or regions are provided with the same reference signs, small letters sometimes being added.

Within the context of the invention, features that are described only with reference to one embodiment can also be provided in all other embodiments of the invention. Embodiments modified in this way are also covered by the invention, even if they are not shown in the drawings.

All the features disclosed are per se essential to the invention. The disclosure of the associated priority documents (copy of the prior application), the cited documents, and the described apparatuses of the prior art is hereby included in its entirety in the disclosure of the application, also for the purpose of incorporating individual or a plurality of features of said documents into one or more claims of the present application.

The drone, denoted in its entirety by 10, forms an essential component of a lightning-protection system that is denoted in its entirety by 36 overall in the figures. This will be explained in the following, first with reference to an embodiment according to FIG. 1:

FIG. 1 shows the drone 10 at a spacing H (shown discontinuously, i.e. not to scale), known as the flight altitude, above the ground 41.

The drone 10 is connected to a ground station 11 by cable 13. The drone 10 thus hovers above a site, in particular above an event site 12 shown in FIG. 1.

In the figures, the drone is shown schematically in the form of a drone. However, the invention in particular also covers the case of the drone 10 being designed in the manner of a helicopter or as a helicopter.

Helicopters are understood in particular to be drones that comprise at least one rotor that rotates about a substantially vertical axis of rotation. In helicopters of this kind, for example angle adjustment of the rotor blades may also take place, using a swash plate, as is known in conventional helicopters for setting the pitch, i.e. setting the inclination or the angle of attack of the rotor blades.

The lightning-protection system 36 is used as a whole for protecting visitors to the event site 12, schematically shown in FIG. 1 as people 17a, 17b, 17c, but also employees, such as musicians 19, from being struck by lightning 14 (shown schematically). By means of the drone 10, the cable 13, and a lightning transfer point 16 arranged within the earth 15, the lightning is safely conducted into the earth, such that the visitors and participants at the event are not in danger.

The drone 10 is arranged at a flight altitude H, above the event site 12. The flight altitude H is in particular higher than the altitude HE of elevations 21 that may be arranged in the region of the event site 12, and also higher than the altitude HB of buildings 20 that may be arranged in the event site 12.

In this respect, in the region or site 12 to be protected by the lightning-protection system 36, the drone 10 is located, in its flight position, at an elevated, in particular at the highest, point. This ensures that lightning 14 first strikes the drone 10 before it hits the ground 41 at another position within the event site 12.

As shown in the schematic FIG. 1, the drone 10 may comprise one or more feet 22a, 22b in order to be able to land safely on the ground 41 again after use. However, feet of this kind are not necessarily required in the drone 10 according to the invention.

The drone 10 further comprises a chassis 23 or another type of frame or structure. The chassis in particular carries a controller 33 as well as further electronic or electromechanical components of the drone.

In the embodiment of FIG. 1, the drone comprises two rotors 25a, 25b (indicated merely by way of example) that are each assigned a separate drive 24a, 24b. The drive is an electromotive drive, i.e. an electric motor. The number of rotors is arbitrary. In this case, conventional arrangements or embodiments of rotors and the drives thereof for what are known as multicopters can be used. For example, 1 to 16 drives and/or motors and rotors may be provided.

As indicated in the embodiment of FIG. 1, one or more lightning antennae 26 may be provided on the drone 10. Said antennae may in particular comprise a metal element or a metal conductor which ends in an exposed position in any form, or protrudes from the shell contour of the drone 10 in another manner, and/or may be formed by or together with a chassis 23 or housing or another component of the drone.

The electronics or controller 33 of the drone 10, and in particular also the electromotive drives 24a, 24b for the rotors 25a, 25b are supplied with operating voltage from the ground station 11 by the cable 13.

The drone 10 can thus permanently maintain and keep a flight position, for example for several hours or days, which position is set once. For this purpose, the ground station 11 is connected for example to a current generator or to the conventional voltage supply network. The operating voltage is transmitted from the ground station 11 to the drone 10 by the cable 13.

FIG. 2 is a cross section of a first embodiment of cable 13. The cable 13 according to FIG. 2 comprises just two conductors 27a, 27b. Said conductors consist of a metal material, in particular copper. Said conductors may be surrounded by insulating sheathing 39a, 39b. The cable 13 can furthermore also comprise stabilizing material 40, in particular a material of the kind that also consist of insulating material.

Advantageously, the cable 13 is as lightweight as possible overall. This requirement is easy to follow because the overall length of the cable 13 may not exceed the maximum useful/bearing load of the drone 10.

The cross section of the two conductors 27a, 27b of the cable according to FIG. 2 is particularly important. In the embodiment of the invention, said overall cross section is at least 10 mm². The overall cross section can be divided over the two conductors 27a, 27b in equal or unequal parts.

In the embodiment of FIG. 2, the cable 13 comprises just two electrical conductors 27a, 27b. In normal circumstances, i.e. when no lightning strikes occur, said conductors are used for transmitting operating voltage from the ground station 11 to the drone 10. The two conductors 27a, 27b can also be used for transmitting control information from the ground station to the drone 10, or in the opposite direction. The control information may be used for example for setting or amending or checking the flight position of the drone 10.

In a further embodiment of the invention, it may be possible for control information for setting or amending the flight position of the drone to be transmitted from the ground station or a mobile controller or another controller on the ground, to the drone 10, wirelessly or by radio.

In the embodiment of FIG. 2, the two conductors 27a, 27b have a sufficiently large cross section, or a sufficiently large overall cross section of at least 10 mm², to be able to transmit the extremely high currents caused in the case of a lightning strike from the drone 10 to the ground station 11 and into the earth 15, via the cable 13.

A connecting cable 32 is arranged in the region of the ground station 11, which connecting cable is guided into the earth 15, at a depth T of preferably approximately 3 meters or more than 3 meters, as far as a transfer point 16. At said point, the lightning strike is transferred to the earth. In this respect, the lightning transfer point 16 is at earth potential or is earthed.

In the case of a lightning strike into the drone 10 according to FIG. 1, the lightning is thus conducted directly into the earth 15. The event on the event site 12 need not be interrupted or stopped, because the visitors 17a, 17b, 17c and the artists 19 are not in danger.

It should be noted that the music event according to FIG. 1 is just one example for possible applications of the lightning-protection system 36 according to the invention.

According to the embodiment of FIG. 3, the cable 13 comprises a plurality of conductors 27a, 27b, 27c, 27d, 27e, 27f, 27g. Said conductors are each surrounded by insulating sheathing 39b, 39c, only some isolating sheathings being provided with reference signs in FIG. 3.

The arrangement of the conductors 27a, 27b, 27c, 27d, 27e, 27f, 27g in the embodiment of FIG. 3 is to be understood merely by way of example. The individual cross sections of the individual conductors may also be the same, as shown in FIG. 3, but may also be entirely different.

It is advantageous for the cable 13 to comprise a plurality of conductors, and for a plurality of said conductors, preferably all the conductors, to participate in conducting away the currents caused by a lightning strike. Specifically, the overall cross section of the conductors can then be kept particularly small. In the case of lightning being conducted away, specific physical effects occur in electrical conductors. Said effects mean that, by distributing the conductor cross sections used for conducting away the lightning over as many conductors as possible, the overall cross section can be kept smaller as a whole.

The conductors provided on the cable 13 are advantageously not only used for arresting the lightning in the case of a lightning strike, but are also used in normal flight operation of the drone 10. The conductors 27a, 27b, 27c, 27d, 27e, 27f, 27g can thus not only transmit operating voltage, but can for example also transmit information, unidirectionally or bidirectionally, between the drone and the ground station 11.

According to the embodiment of FIG. 4, the drone 10 additionally comprises a communications unit 28. Together with outstations 29a, 29b that are arranged for example on the ground 41, said communications unit can form a radio network. Audio data or video signals or other information or data can be transmitted via said radio network.

The cable 13 provided in this embodiment is shown in cross section in FIG. 5a. It can be seen here that a fiber optic cable 30 is provided in addition to four electrical conductors 27a, 27b, 27c, 27d. The number of electrical conductors 27a, 27b, 27c, 27d was selected merely by way of example in this embodiment. For example, the two conductors 27a and 27b can be used for transmitting an operating voltage for the drives of the drone 10. In contrast, the two further conductors 27c and 27d can provide for transmission of the operating voltage for the communications unit 28.

However, the conductors can also be used for other different applications, and different voltages or different signals may be transmitted.

Optical signals can be transmitted via the fiber optic cable 30, it being possible for electro-optical or optoelectronic transducers to be provided both in the region of the ground station 11 and in the region of the drone 10. However, the high current generated in the case of a lightning strike cannot be conducted away through the fiber optic cable. The electrical conductors 27a, 27b, 27c, 27d are provided for this purpose, the overall cross section of which conductors again amounts to at least 5 mm², preferably at least 10 mm².

Radio data can be transmitted unidirectionally or bidirectionally via the fiber optic cable 30 in order for the drone 10 to be able to participate in the radio network as a subscriber.

However, information, data and signals can also be transmitted between the ground station 11 or a controller 31 of the ground station 11, and the drone 10 or a controller 33a, 33b of the drone 10 can also be transmitted via the fiber optic cable 30, for example in order to control and/or to influence and/or to correct the flight position of the drone 10.

Of course, the illustration by way of example of a cross section of the cable 13 according to FIG. 5a, just like that according to FIGS. 2 and 3, is to be understood to be merely schematic. Advantageously, the cable has an overall cross section that is substantially circular or that approximates a circle or that is in any case free of projections, and in which all the electrical and optical conductors, if provided, are integrated.

According to the embodiment shown schematically in FIG. 5b, the fiber optic cable 30 consists of twelve individual fiber optic strands 30a, 30b, 30c, the remaining fiber optic strands being shown but not provided with reference signs. The number of fiber optic strands is irrelevant, however. The bundle of the twelve fiber optic strands 30a, 30b, 30c is arranged approximately over a substantially circular cross section. Furthermore, a sheath 44 can optionally be provided.

Twelve electrical conductors 27a, 27b, 27c, etc. are arranged around said sheath 44. A further sheath 45 is provided around said twelve conductors, such that the cross section of the cable according to FIG. 5b forms a substantially circular cross section overall. The sheath 45, as well as the sheath 44, may consist of plastics material or a textiles material for example. A material such as PVC or polyurethane is furthermore possible.

In order to avoid repetitions, with respect to the design of a drone 10 using a communications unit 28 for forming a radio network reference is made to the subsequently published German patent application DE 10 2017 105 956.3 [US 2018/0273171] by the applicant, the contents of which is hereby included in the contents of the present patent application, also for the purpose of incorporating individual features in the claims of this application.

The design of a drone 10, shown in the manner of a block diagram, will now be explained in accordance with FIG. 6.

In this embodiment, the drone 10 (shown by way of example) comprises two lightning antennae 26a, 26b. The number of lightning antennae 26 is arbitrary, however. FIG. 6 is merely intended to show that the lightning antennae 26a, 26b can protrude outwards from a housing 42 of the drone 10 or from a shell contour 42 of the drone 10.

In this embodiment, the lightning antennae 26a, 26b are directly connected to the cable 13. Since FIG. 6 is an illustration in the form of a block diagram, the detailed connection is not shown here.

In the simplest case, the cable 13 can be used for supplying voltage to the drone 10 and can additionally comprise an electrical conductor that is provided as a separate conductor for conducting away the lightning current.

FIG. 6 actually shows that the lightning antennae 26a, 26b are directly connected to the cable 13. In this case, it may be possible for an electrical connection to be established, in some circumstances only briefly, among a plurality of conductors 27a, 27b, 27c, 27d, 27e, 27f, 27g on the cable 13 for example, in the case of very high voltages or very high currents occurring. In contrast, in normal circumstances, i.e. in the case of no lightning striking, the individual conductors 27a, 27b, 27c, 27d, 27e, 27f, 27g can be electrically isolated from one another.

In the embodiment of FIG. 6, a controller 33a of the drone 10 is provided that is connected to the cable 13 via an electrical cable 35b, an electronic component part 34e and a further electrical cable 35a. The controller 33a is connected to the motorized drive 24a for the rotor 25a by an electrical cable 35c. At the same time, the controller 33a is connected to the electromotive drive 24b for the rotor 25b by an electrical cable 35d.

As is already the case in the previous embodiments, the number of rotors 25a, 25b is arbitrary.

The controller 33a ensures or jointly ensures that a set flight position of the drone 10 at a flight altitude H above the event site 12 is maintained. For this purpose, said controller can supply the rotors 25a, 25b with the necessary supply voltage for the drives 24a, 24b and also with the necessary motor capacity. Similarly, for example one or more position sensors may also be provided in the drone 10 and connected to the controller 33a in order to maintain a set flight position even in the event of wind, and over long time period of for example several days.

In normal circumstances, the controller 33a receives its supply voltage via the cable 13. According to the embodiment of FIG. 6, the lightning antenna 26b is likewise connected to the cable 13. In order to then prevent the controller 33a from failing in the event of a lightning strike, a lightning-protection means 34a is provided. According thereto, the lightning controller 34a is provided between the cable 13 and the controller 33a.

The lightning-protection means 34a may be a surge arrester for example. In the event of high voltages occurring, i.e. in the case of a lightning strike, at the input side of the lightning-protection means 34a, a permanent or brief interruption of the connection between the controller 33a and the cable 13 can be ensured in order to protect the controller 33a from voltages or currents that are too high.

In order to ensure brief bridging, the controller 33a may for example also be connected to a battery 43 which bridges brief outages in the voltage supply.

Alternatively, the controller 33a can also be designed, in interaction with the lightning-protection means 34a, in such a way that the controller automatically intervenes again immediately after a brief outage, for example after just fractions of a second.

The lightning-protection means 34a ensures in any case that the controller 33a and all the electronic component parts and devices connected thereto, for example also the electromotive drives 24a, 24b, are protected from surges.

In addition, the housing 42 of the drone 10 can be designed in the manner of a Faraday cage and can ensure that no undesired high voltages can penetrate into the interior of the Faraday cage 42 itself.

According to the embodiment of FIG. 6, the controller 33a is furthermore redundant. For this purpose, the second controller 33b is provided with a second lightning-protection means 34b and the corresponding connecting cables 35e, 35f, 35g, 35h.

In the event of the controller 33a failing for any reason, for example because the lightning-protection means 34a has failed, the controller 33b can immediately take over the control of the drone. For this purpose, all the relevant information can be permanently reflected to the two controller 33a and 33b even while the drone 10 is being programmed, for example while the flight position is being set.

For the sake of clarity, it is noted that the controller 33a, 33b may for example comprise microprocessors and also memories, for example volatile and non-volatile memories.

The embodiment of FIG. 7 relates to an assembly that substantially corresponds to the drone 10 of FIG. 6. In this case, a communications unit 28 is additionally provided, as has already been explained in the embodiment of FIG. 4 and FIG. 5a.

In this embodiment, the communications unit 28 is also assigned lightning-protection means 34c which ensures, in the case of a lightning strike, that the communications unit 28 continues to remain able to communicate. In an embodiment of the invention the communications unit 28 may also be redundant (not illustrated in FIG. 7), in order to thus ensure for increased failure-safety.

The embodiment of FIG. 8 relates to an assembly that is modified compared with the embodiment of FIG. 6. In this case, the lightning-protection means 34a, 34b is directly connected to the controller 33a and 33b, respectively, but is not directly connected to the cable 13.

The embodiment of FIG. 9 finally shows a further alternative design. In this case, a lightning-protection means 34a, 34b is again provided and is connected to the relevant controller 33a, 33b. In this case, however, the corresponding lightning antenna 26a, 26b is directly connected to the relevant lightning-protection means 34a, 34b.

The embodiment of FIG. 10 shows a lightning-protection system in which a plurality of drones 38a, 38b, 38c, 38d, 38e, 38f of the type according to the invention are used. FIG. 10 is a view from above of an event site 12, only the drones 38a, 38b, 38c, 38d, 38e, 38f being shown. Said devices are arranged at regular spacings, in the manner of grid points or in the manner of a raster. The maximum spacings are denoted MAX or MAY. The raster develops along an X-Y plane. All the drones 38a, 38b, 38c, 38d, 38e, 38f may be arranged at the same flight altitude H or at different altitudes.

It has been found that adhering to maximum spacings of 80 meters (i.e. MAX=80 meters and MAY=80 meters) already makes it possible to ensure sufficient protection from lightning strikes. The invention also covers maximum spacings of for example 40 meters or less between two adjacent drones.

The ground station 11 can also comprise lightning-protection means (not shown in the drawings), in order for example to protect a controller 31 of the ground station 11 and/or other electronic or electrical elements of the ground station 11 from being impaired or damaged by lightning strikes.

1. A drone comprising:
an electromotive drive;
a controller connected to the drive for maintaining the drone in a set flight position;
a cable connecting the drone in its flight position to a ground station and having at least two electrical conductors for supplying voltage to the drive; and
lightning-protection means for protecting the controller and/or the drive and/or other electronic component parts of the drone from lightning strikes, an overall cross section of the electrical conductors of the cable being capable of conducting for high electrical currents caused by lightning strikes away from the drone to the ground station, the cable being connected to a lightning transfer point in the earth in the region of the ground station.

2. The drone according to claim 1, wherein the lightning transfer point is at a depth in the earth of at least 1 m.

3. The drone according to either claim 1, wherein the lightning-protection means comprises a surge arrester and/or has a redundant configuration of electronic component parts of the drone.

4. The drone according to claim 1, wherein the electrical conductors of the cable are copper conductors.

5. The drone according to claim 1, wherein an overall cross section of all the electrical conductors of the cable is at least 5 mm².

6. The drone according to claim 1, wherein the flight position of the drone can be set.

7. The drone according to claim 1, wherein the cable comprises a plurality of conductors, all or at least some of which contribute to conducting away lightning strikes.

8. The drone according to claim 1, further comprising:
a communications unit that can establish wireless communication with other subscribers of a radio network.

9. The drone according to claim 8, wherein the cable has a fiber optic cable that can transmit data from the ground station to the communications unit and/or that can transmit data from the communications unit to the ground station.

10. A lightning-protection system for achieving lightning-protection for a site, comprising:
a ground station,
a drone having an electromotive drive and a controller for keeping a flight position once the position has been set,
a cable having connecting the drone to the ground station and having two electrical conductors for supplying voltage to the drive, the cable conducting lightning away from the drone, and
means for connecting the cable directly or indirectly to the earth.

11. The lightning-protection system according to claim 10, wherein the drone comprises lightning-protection means.

12. The lightning-protection system according to claim 11, wherein the lightning-protection means protects the controller and/or the drive from lightning strikes.

13. The lightning-protection system according to claim 10, wherein an overall cross section of the electrical conductors of the cable is sufficiently large to conduct high electrical currents caused by lightning strikes away from the drone to the ground station.

14. The lightning-protection system according to claim 10, wherein the cable is connected to a lightning transfer point in the earth in the region of the ground station.

15. The lightning-protection system according to claim 1, wherein the lightning-protection system comprises a plurality of the drones that each remain in their respective flight positions at a specified spacing from one another.

16. The lightning-protection system according to claim 10, wherein the lightning-protection system comprises a plurality of ground stations.

17. The lightning-protection system according to claim 15, wherein one ground station is connected to respective drone.

18. The lightning-protection system according to claim 10, wherein the ground station is mobile.

19. The lightning-protection system according to claim 10, wherein the lightning-protection system is mobile.

20. A method of providing lightning-protection for a site, the method comprising the following steps:
providing a ground station, a drone and a cable having electrical conductors having a sufficiently large overall cross section capable of conducting away high electrical currents caused by lightning strikes,
connecting the drone to the ground station by the cable and electrically connecting the cable to the earth,
setting a flight position for the drone, and maintaining the set flight position using a controller in the drone,
supplying the drone with operating current from the ground station via the cable,
providing lightning-protection for the site by conducting away into the earth via the cable the lightning that has struck the drone in the event of a lightning strike.
